(19) United States
(12) Patent Application Publication
(10) Pub. No.: US 2013/0201037 A1
(43) Pub. Date: Aug. 8, 2013

(54) DISPLAY OF AN AIRCRAFT TAXI CLEARANCE

(71) Applicants: J. Howard Glover, Redmond, WA (US); Jan Flasar, Brno (CZ); Stephen Whitlow, St. Louis Park, MN (US); Tomas Kabrt, Prague (CZ); Tomas Marczi, Beroun (CZ)

(72) Inventors: J. Howard Glover, Redmond, WA (US); Jan Flasar, Brno (CZ); Stephen Whitlow, St. Louis Park, MN (US); Tomas Kabrt, Prague (CZ); Tomas Marczi, Beroun (CZ)

(73) Assignee: HONEYWELL INTERNATIONAL INC., Morristown, NJ (US)

(21) Appl. No.: 13/366,879

(22) Filed: Feb. 6, 2012

(51) Int. Cl. G08B 21/00

(52) U.S. Cl. 340/945

(57) ABSTRACT

A method and system are described for enhancing ground situational awareness to an aircrew via the display of an air traffic control ground clearance, including displaying a symbol for each stage of the clearance and highlighting each symbol when the aircraft occupies that stage. A stage is highlighted when the aircraft is to hold short of that stage. Additional highlights may be included as an alert.

### TECHNICAL FIELD

The present invention generally relates to ground operation of aircraft and more particularly to a method and system displaying a traffic ground control clearance on an aircraft display.

### BACKGROUND OF THE INVENTION

It is important for pilots to comprehend an issued ground clearance when taxing. Navigation of an airport surface (taxiways/runways) can be as difficult (from a pilot's workload perspective) as the airborne portion of the flight, especially in limited visibility of night and/or weather, or at unfamiliar airports. An increase in pilot workload typically results in an increase in cognitive errors and a decreased attention span: the pilot must interpret and integrate the information provided from several sources occupying his thought processes when he may have many other decisions to make. Some unlikely, yet postulated results include taxing onto unapproved taxiways/runways and becoming disorientated while taxing.

As terminal area operations increase in volume, complexity, and required execution precision, pilots need to understand ground (taxi) clearances issued by ground control. Clearances may be represented in text via data link such as “cleared to 3-4 left on A10 via Alpha Bravo, stop and hold short of 1-1”. This presents the clearance but neither indicates the current progress of the aircraft through the clearance nor is it amenable to an intuitive representation to indicate the limits of the clearance. While next generation Airport Moving Maps (AMM) provide a spatial representation of a taxi clearance, the details of the clearance can be lost in the graphical rendering, especially if an attempt is made to glean awareness from the AMM at a glance. AMMs are an overlay, for example, on a multi-function display/integrated navigation display (MFD/INAV), where airport features like runways, taxiways, and aprons, are shown on the display.

Accordingly, it is desirable to provide a method and system displaying ground clearance instructions to the aircrew of an aircraft on the ground in an airport environment that may be more easily understood by the pilot. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A method and apparatus are disclosed that presents symbols on a cockpit display, e.g., an Airport Moving Map (AMM), for simultaneously and intuitively displaying the current taxi clearance (instruction), the progress of the aircraft through the route of the clearance, clearance limits, and any alerts associated with any segments of the route/clearance.

A first exemplary embodiment is a method for displaying taxi instructions to a pilot of an aircraft, the instructions defining a plurality of positions on an airfield, comprising displaying a plurality of symbols, each symbol representing one of the positions; and highlighting each symbol when the aircraft occupies the position represented by that symbol.

A second exemplary embodiment is a method for displaying taxi instructions, defining a plurality of positions, to a pilot of an aircraft, comprising displaying a symbol for each position of the instructions; and applying a first highlight to each symbol when the aircraft occupies the position represented by that symbol.

A third exemplary embodiment is a system for displaying taxi instructions, including a plurality of positions, to a pilot of an aircraft, the system comprising a display; and a processor configured to display a symbol for each position of the clearance; and apply a first highlight to each symbol when the aircraft occupies the position represented by that symbol.

### BRIEF DESCRIPTION OF THE DRAWINGS

The present invention will hereinafter be described in conjunction with the following drawing figures, wherein like numerals denote like elements, and

FIG. 1 is a functional block diagram of a flight display system;

FIGS. 2-9 are graphical representations of a clearance as an aircraft proceeds through the route of the clearance in accordance with a first exemplary embodiment that may be rendered on the flight display system of FIG. 1; and

FIG. 10 is a flow chart of the steps of a process for displaying a ground clearance on a display of an aircraft, in accordance with the exemplary embodiment.

### DETAILED DESCRIPTION OF AN EXEMPLARY EMBODIMENT

The following detailed description of the invention is merely exemplary in nature and is not intended to limit the invention or the application and uses of the invention. Furthermore, there is no intention to be bound by any theory presented in the preceding technical field, background, brief summary, or the following detailed description.

A method and apparatus are disclosed that presents symbols on a cockpit display, e.g., an Airport Moving Map (AMM), for simultaneously and intuitively displaying the current taxi clearance (instruction), the progress of the aircraft through the route of the clearance, clearance limits, and any alerts associated with any segments of the route/clearance. The display is compact and provides immediate pilot situational awareness at a glance, and may include color coding that is consistent with flight deck conventions in terms of proposed versus accepted clearance and alerting.

These disclosed exemplary embodiments greatly reduce clutter on the display while the awareness of the ground clearance are clear and precise.

While the exemplary embodiments described herein refer to displaying the information on aircraft, the invention may also be applied to other exemplary embodiments, for example, displays in sea going vessels and displays used by traffic controllers.

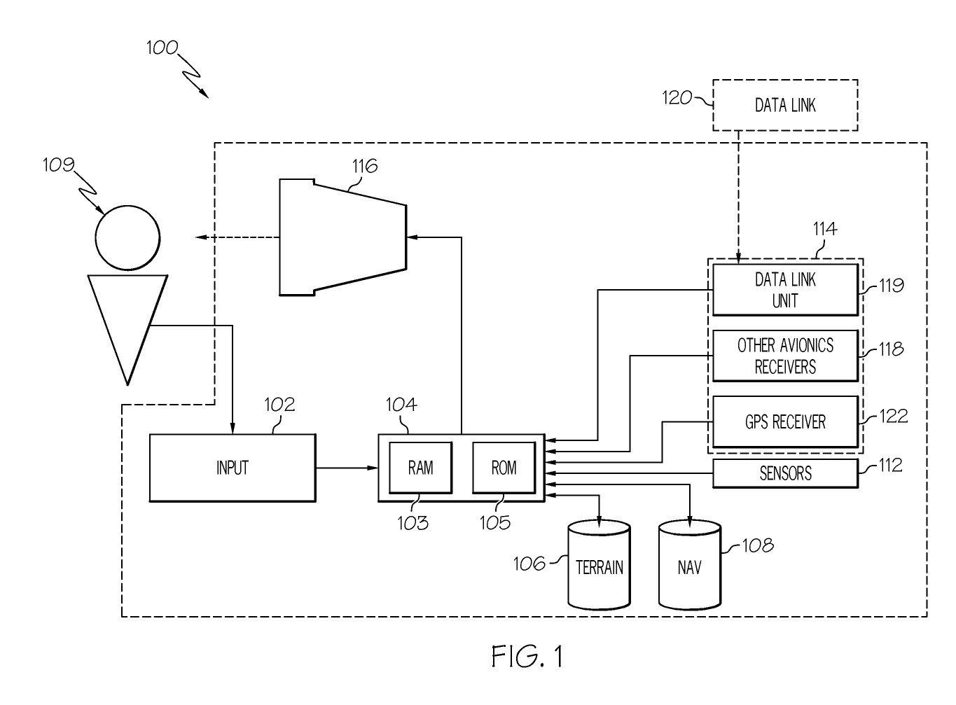

Referring to FIG. 1, an exemplary flight deck display system 100 is depicted and will be described for displaying aircraft ground clearances. The system 100 includes a user interface 102, a processor 104, one or more terrain/taxiway databases 106, one or more navigation databases 108, various optional sensors 112 (for the cockpit display version), various external data sources 114, and a display device 116. In some embodiments the user interface 102 and the display device 116 may be combined in the same device, for example, a touch pad. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, a cursor control device (not shown), such as a mouse, a trackball, or joystick, and/or a keyboard, one or more buttons, switches, or knobs.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

No matter how the processor 104 is specifically implemented, it is in operable communication with the terrain/taxiway databases 106, the navigation databases 108, and the display device 116, and is coupled to receive various types of aircraft state data from the various sensors 112, and various other environment related data from the external data sources 114. The processor 104 is configured, in response to the inertial data and the avionics-related data, to selectively retrieve terrain data from one or more of the terrain/taxiway databases 106 and navigation data from one or more of the navigation databases 108, and to supply appropriate display commands to the display device 116. The display device 116, in response to the display commands from, for example, a touch screen, keypad, cursor control, line select, concentric knobs, voice control, and datalink message, selectively renders various types of textual, graphic, and/or iconic information. The preferred manner in which the textual, graphic, and/or iconic information are rendered by the display device 116 will be described in more detail further below. Before doing so, however, a brief description of the databases 106, 108, the sensors 112, and the external data sources 114, at least in the depicted embodiment, will be provided.

The terrain/taxiway databases 106 include various types of data representative of the surface over which the aircraft is taxing, the terrain over which the aircraft is flying, and the navigation databases 108 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the terrain/taxiway databases 106 and the navigation databases 108 are, for clarity and convenience, shown as being stored separate from the processor 104, all or portions of either or both of these databases 106, 108 could be loaded into the RAM 103, or integrally formed as part of the processor 104, and/or RAM 103, and/or ROM 105. The terrain/taxiway databases 106 and navigation databases 108 could also be part of a device or system that is physically separate from the system 100.

The sensors 112 may be implemented using various types of sensors, systems, and or subsystems, now known or developed in the future, for supplying various types of aircraft state data. The state data may also vary, but preferably include data representative of the geographic position of the aircraft and also other data such as, for example, aircraft speed, heading, altitude, and attitude.

The number and type of external data sources 114 (or subsystems) may also vary, but typically include for example, a GPS receiver 122, other avionics receivers 118, and a data link unit 119. The other avionics receivers would include, for example, a terrain avoidance and warning system (TAWS), a traffic and collision avoidance system (TCAS), a runway awareness and advisory system (RAAS), a flight director, and a navigation computer.

The GPS receiver 122 is a multi-channel receiver, with each channel tuned to receive one or more of the GPS broadcast signals transmitted by the constellation of GPS satellites (not illustrated) orbiting the earth. Each GPS satellite encircles the earth two times each day, and the orbits are arranged so that at least four satellites are always within line of sight from almost anywhere on the earth. The GPS receiver 122, upon receipt of the GPS broadcast signals from at least three, and preferably four, or more of the GPS satellites, determines the distance between the GPS receiver 122 and the GPS satellites and the position of the GPS satellites. Based on these determinations, the GPS receiver 122, using a technique known as trilateration, determines, for example, aircraft position, groundspeed, and ground track angle. These data may be supplied to the processor 104, which may determine aircraft glide slope deviation therefrom. Preferably, however, the GPS receiver 122 is configured to determine, and supply data representative of, aircraft glide slope deviation to the processor 104.

The display device 116, as noted above, in response to display commands supplied from the processor 104, selectively renders various textual, graphic, and/or iconic information, and thereby supply visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 116 may additionally be implemented as a panel mounted display, a HUD (head-up display) projection, or any one of numerous known technologies. It is additionally noted that the display device 116 may be configured as any one of numerous types of aircraft flight deck displays. For example, it may be configured as a multi-function display, a horizontal situation indicator, or a vertical situation indicator, just to name a few. In the depicted embodiment, however, the display device 116 is configured as a primary flight display (PFD).

Onboard data link 119 is coupled to external data link 120 and is configured to receive data from ground stations and other aircraft. Examples of the data received include, for example, weather information, traffic information, route changes, and specifically clearances and alerts describing, for example, hazardous situations. In accordance with the present exemplary embodiments, the onboard data link unit 119 receives ADS-B information from external data link 120.

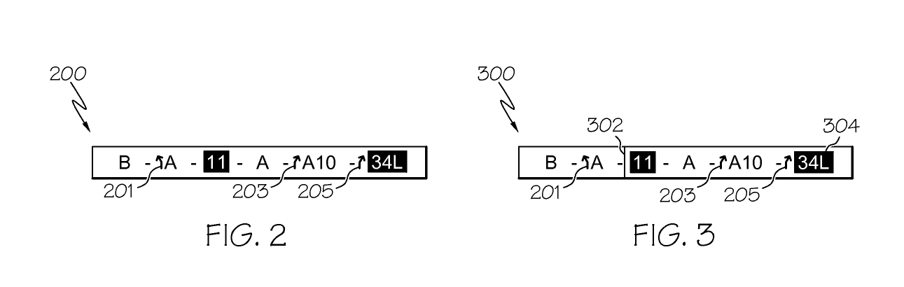

With reference to FIG. 2, a graphical image 200 for displaying on the display 116 is a ground clearance (taxi instructions) in accordance with a first exemplary embodiment. As shown, the ground clearance may be stated as “cleared to 34L on A10 via Bravo Alpha, stop and hold short of one-one”. The symbols Alpha (represented by the letter “A”), Bravo (represented by the letter “B”) and A10 are taxiways and the symbols one-one (represented by “11”) and 34L are runways. Preferably, the symbols 11 and 34L are represented in white on a dark background, as shown, to resemble the actual runways. Data for the ground clearance is received via the data link 120 by the data link unit 119 and stored in the ROM 105 and is processed by the processor 104 for display

When the pilot accepts the clearance, the graphical image 300 (FIG. 3) appears (in place of graphical image 200) wherein a line 302 appears prior to (the left of) the “11”, meaning the aircraft is not to proceed onto (in order to cross) runway 11, and 34L is highlighted (by a unique color, for example) with a box 304 appearing around the 34L indicating runway 34L to indicate an alert or some factor that may affect operation of the aircraft on runway 34L. Such alert or factor could be, for example, a traffic conflict (another aircraft on the runway), or that an incompatibility exists between the aircraft and the taxiway, for example, airplane weight and load-bearing strength of the taxiway. This alert could be independent of the clearance from ATC, such as if the controller made an error. Additionally, one or more arrows 201, 203, 205 may be included to indicate the direction the aircraft is to turn on the next taxi or runway. For example, the arrow 201 indicates a left turn onto taxiway A, the arrow 203 indicates a right turn onto taxiway A10, and the arrow 205 indicates a right turn onto the runway 34L. The arrows 201, 203, 205 could take any format, for example, they could be curved to indicate the turn or may be larger than the associated symbol. Highlighting as used herein means to differentiate the symbol from the non-differentiated symbol, and may include an adjacent icon, or a change in format, for example, a change in color, size, font, and background.

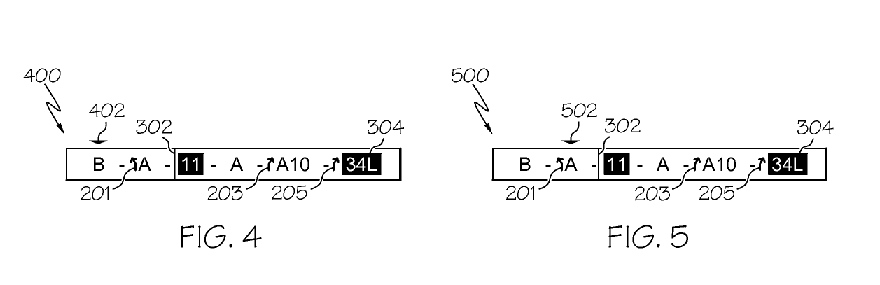

As the aircraft enters taxiway Bravo (represented by “B” on the display), the graphical image 400 (FIG. 4) is displayed wherein the “B” is highlighted as represented by an icon 402 adjacent the “B”. The location of the taxiways and runways is provided by the terrain/taxiway database 106 and the position of the aircraft is provided by the GPS receiver 122. As the aircraft turns left onto taxiway Alpha (represented by the arrow 201 and “A” on the display), the graphical image 500 (FIG. 5) is displayed wherein the “A” is highlighted as represented by an icon 502 adjacent the “A”, and the icon 402 is removed. Because of the instructions to hold short of runway 11 (indicated by the line 302), the pilot must remain on taxiway Alpha (represented by “A”) until further clearance is received.

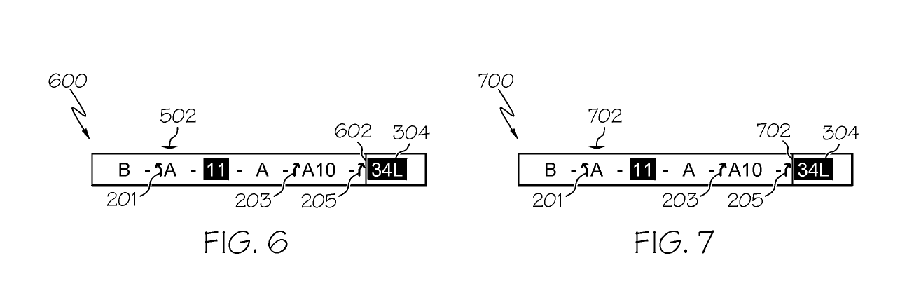

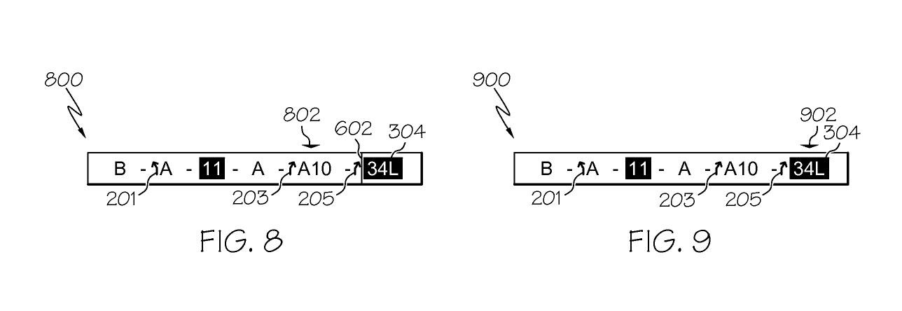

When the hold restriction is removed and clearance to proceed is given, the graphical image 600 (FIG. 6) is displayed wherein the hold line 302 has been deleted. When this clearance to proceed is given, a “hold short of runway 34L” may be given which would cause the hold line 602 to appear to the left of “34L”. As the aircraft taxis onto (crosses) runway one-one (represented by “11” on the display), the graphical image 700 (FIG. 7) is displayed wherein the “11” is highlighted as represented by an icon 702, and the icon 502 is removed.

As the aircraft turns left onto taxiway A10 (represented by the arrow 203 and “A10” on the display), the graphical image 800 (FIG. 8) is displayed wherein the “A10” is highlighted as represented by an icon 802 adjacent the “A10”, and the icon 702 is removed.

When clearance is received to taxi onto runway 34L to hold, or clearance for takeoff on runway 34L has been given, the hold line 602 is removed, the highlight of stage 34L (box 302) is removed or changed to indicate the alert is no longer valid, and the aircraft may proceed onto runway 34L. As the aircraft taxis right (as indicated by the arrow 205) onto runway 34L, the graphical image 900 (FIG. 9) is displayed wherein the “34L” is highlighted as indicated by the icon 902 and the icon 802 is removed. Furthermore, the box 304 may change format to indicate, for example, that the runway is clear of other traffic.

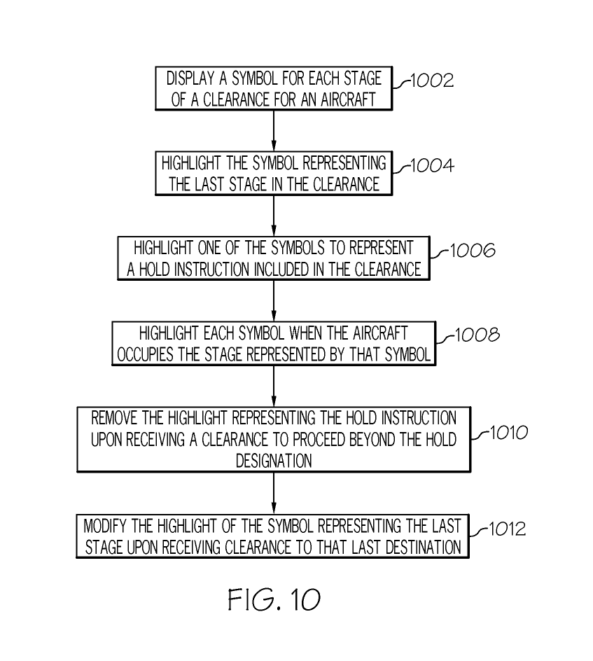

FIG. 10 is a flow chart of the steps of an exemplary process 1000 for enhancing situational awareness of a crew by displaying graphical representations of a clearance as an aircraft proceeds through the route of the clearance in accordance with a first exemplary embodiment. The various tasks performed in connection with process 1000 may be performed by software, hardware, firmware, or any combination thereof. For illustrative purposes, the following description of process 1000 may refer to elements mentioned above in connection with FIG. 1. In practice, portions of process 1000 may be performed by different elements of the described system, e.g., a processor, a display element, or a data communication component. It should be appreciated that process 1000 may include any number of additional or alternative tasks, the tasks shown in FIG. 10 need not be performed in the illustrated order, and process 1000 may be incorporated into a more comprehensive procedure or process having additional functionality not described in detail herein. Moreover, one or more of the tasks shown in FIG. 10 could be omitted from an embodiment of the process 1000 as long as the intended overall functionality remains intact.

Referring to FIG. 10, the method of displaying a clearance, including a plurality of stages, to a pilot of a craft includes displaying 1002 a symbol for each stage of the clearance in series, highlighting the symbol representing the last stage of the clearance; highlighting one of the symbols to represent a hold instruction; highlighting each symbol when the aircraft occupies the stage represented by that symbol; removing the highlight representing the hold instruction upon receiving a clearance to proceed beyond the hold; and modifying the highlight of the symbol representing the last stage upon receiving clearance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for displaying taxi instructions to a pilot of an aircraft, the instructions defining a plurality of positions on an airfield, comprising:
displaying a plurality of symbols, each symbol representing one of the positions; and
highlighting each symbol when the aircraft occupies the position represented by that symbol.

2. The method of claim 1 further comprising:
highlighting one of the symbols to represent a hold instruction.

3. The method of claim 2 wherein the highlighting one of the symbols comprises:
displaying a line to the left of the highlighted one of the symbols.

4. The method of claim 3 further comprising:
removing the line in response to further taxi instructions.

5. The method of claim 1 further comprising:
displaying the symbols in series in the order in which the aircraft is to taxi.

6. The method of claim 1 further comprising:
highlighting one of the symbols to indicate an alert for that stage.

7. The method of claim 6 further comprising:
removing the highlight from the one of the symbols when a cause of the alert is no longer applicable.

8. The method of claim 1 further comprising:
displaying an arrow to the left of at least one of the symbols indicating a direction of turn onto the position represented by that symbol.

9. A method for displaying taxi instructions, defining a plurality of positions, to a pilot of an aircraft, comprising:
displaying a symbol for each position of the instructions; and
applying a first highlight to each symbol when the aircraft occupies the position represented by that symbol.

10. The method of claim 9 further comprising:
applying a second highlight to one of the symbols to represent a hold instruction

11. The method of claim 10 wherein the applying a second highlight comprises:
displaying a line to the left of the symbol.

12. The method of claim 10 further comprising:
removing the second highlight upon receipt of further taxi instructions.

13. The method of claim 9 further comprising:
applying a second highlight to one of the symbols as an alert.

14. The method of claim 9 further comprising:
applying a second highlight to the symbol representing the last stage of the clearance.

15. The method of claim 9 further comprising:
displaying the symbols in series in the order in which the aircraft is to taxi.

16. A system for displaying taxi instructions, including a plurality of positions, to a pilot of an aircraft, the system comprising:
a display; and
a processor configured to
display a symbol for each position of the clearance; and
apply a first highlight to each symbol when the aircraft occupies the position represented by that symbol.

17. The system of claim 16 wherein the processor is further configured to:
apply a second highlight to one of the symbols to represent a hold instruction.

18. The system of claim 17 wherein the processor is further configured to:
remove the second highlight upon receipt of further ground clearance.

19. The system of claim 16 wherein the processor is further configured to:
apply a second highlight to one of the symbols as an alert.

20. The system of claim 16 wherein the processor is further configured to:
apply a first highlight to the symbol representing the last position of the clearance.
